(19) United States
(12) Patent Application Publication
(10) Pub. No.: US 2015/0193390 A1
(43) Pub. Date: Jul. 9, 2015

(54) VISITED HYPERLINK APPEARANCE BASED ON USER ACTIVITY

(71) Applicant: Google Inc., Mountain View, CA (US)

(72) Inventors: Zoltan Stekkelpak, Sunnyvale, CA (US); Tomer Amarilio, Cupertino, CA (US)

(73) Assignee: Google Inc., Mountain View, CA (US)

(21) Appl. No.: 13/692,517

(22) Filed: Dec. 3, 2012

(51) Int. Cl. G06F 17/22

(52) U.S. Cl. CPC G06F 17/2235

(57) ABSTRACT

Systems and methods for changing visited hyperlink appearance based on user activity are described. One method includes visually indicating a user's browsing history on a results page, detecting an accidental selection of a result, the detecting being effected based on a length of time spent browsing a selected web page, changing the results page to provide a visual indication distinguishing the result accidentally selected from other selected results, and displaying the revised results page.

### BACKGROUND

This disclosure relates generally to rendering web pages, and more particularly, to the appearance of visited and unvisited hyperlinks within a web page.

Hyperlinks on a web page are generally associated with readable text and a target. Hyperlinks are generally displayed with a color different than normal text (an unvisited color). The unvisited color of the readable text indicates to a user that the readable text is a hyperlink that can be selected to navigate to the target of the hyperlink (e.g. a web page). After the hyperlink is used to navigate to its target, the readable text of the hyperlink (hyperlink text) is displayed with another color (visited color), letting the user know that he has already visited the target of the hyperlink.

### BRIEF SUMMARY

Embodiments of the invention are directed to a changing visited hyperlink appearance based on user activity. Embodiments of the invention include a method for visually indicating a user's browsing history on a results page. The method includes detecting an accidental selection of a result, the detecting being effected based on a length of time spent browsing a selected web page. The method also includes changing the results page to provide a visual indication distinguishing the result accidentally selected from other selected results. The method also includes displaying the revised results page.

Embodiments of the invention also include where the visual indication is a change in color of the result. Other embodiments include changing the color of the result using by modifying an attribute of a web page document object model node using JavaScript. Other embodiments include where the length of time is provided by a user setting and synchronizing those user settings with a remote server. Embodiments also include where the results page is a search results page including a plurality of hyperlinks. Embodiments also include where the order of the plurality of hyperlinks is based on the other selected results. Embodiments also include storing a target web page and time of selection of the accidental selection in a database, receiving an indication to return to the results page, and computing a visit duration based on the stored time of selection, and a received indication to return to the result page.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 shows an example web page with visited hyperlinks rendered in accordance with an embodiment of the invention.

FIG. 2 is an architecture diagram showing a system for changing the appearance of visited hyperlinks in accordance with an embodiment of the invention.

FIG. 3 is a flow diagram showing changing visited hyperlink color in accordance with an embodiment of the invention.

FIG. 4 is a system diagram that can be used to implement embodiments of the invention.

### DETAILED DESCRIPTION

Embodiments of the invention are directed to using at least two different visual appearances for visited hyperlinks to provide more information to a user about their browsing than the binary information provided by use of visited and unvisited hyperlink colors. The greater number of visual appearances for visited hyperlinks can correspond to any number of metrics about the user's browsing behavior with respect to the targets of the hyperlinks. This behavior can be measured at the client (e.g. within a web browser), at a server, or using a combination of both systems.

Embodiments of the invention are also directed to continuously changing visited hyperlink appearance over time between a visited and an unvisited appearance. This provides a user real time information on their past browsing history.

Embodiments of the invention are also directed to rearranging the order of hyperlinks on a page in response to a user's browsing habits. Rearranging of hyperlinks can be performed on a search results page containing a list of hyperlinks in response to a user query.

Visual Appearance of Visited Hyperlinks

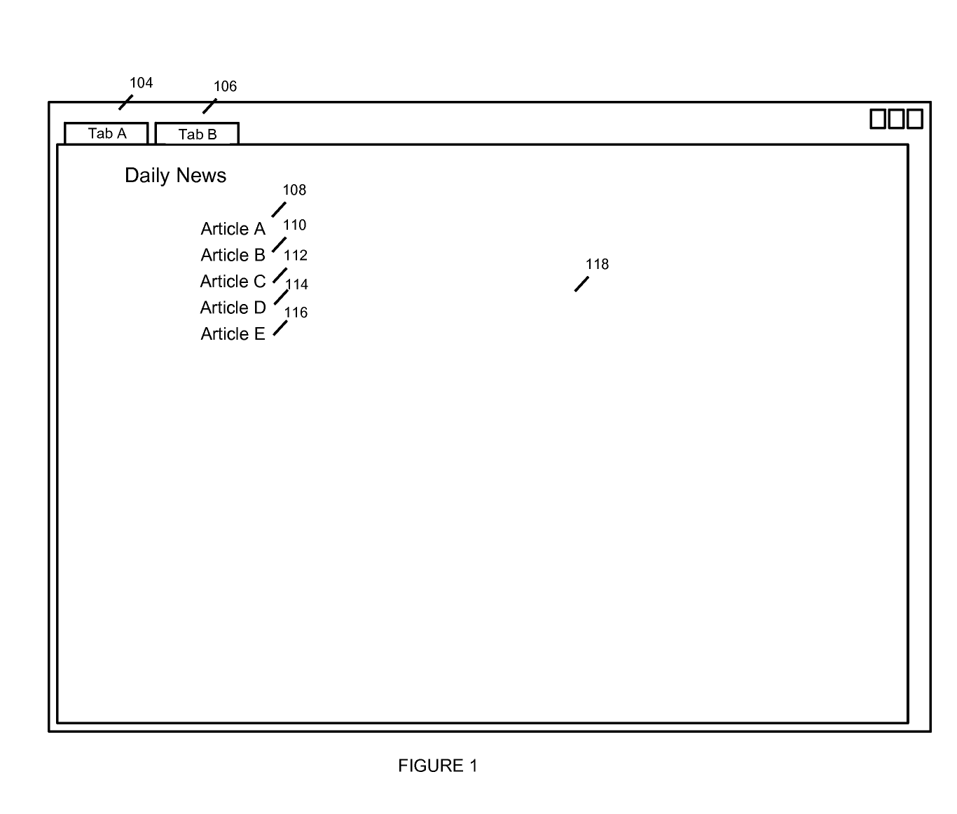

FIG. 1 shows an example web page with visited hyperlinks rendered in accordance with an embodiment of the invention. Web browser 102 is shown with two tabs 104 and 106. The content area 118 of Tab B 106 shows a rendered web page including hyperlinks to five articles 108-116. Article A is shown with an unvisited hyperlink color. Articles B-E 110-116 are shown with visited hyperlink colors that transition to a final visited hyperlink color 116 representing a highly visited target. In some embodiments, this final hyperlink color may be the same as the visited hyperlink color provided in previous systems with only unvisited and visited hyperlink colors. Although only 4 visited hyperlink colors are shown, any number of colors, in any increments can be used. The use of more than two colors, visited and unvisited, provides more information to the user about their browsing behavior, as described further below.

In some embodiments of the invention, others visual distinctions between the visited and unvisited hyperlinks, and between the various visited hyperlinks, can be used. For example, multiple different colors can be used instead of transition colors between an unvisited color and a visited color. For example, red can be used for unvisited hyperlinks, yellow for hyperlinks visited for a short time, and green for hyperlinks visited a long time. Similarly, red can be used for unvisited hyperlinks, yellow for hyperlinks visited infrequently, and green for hyperlinks visited frequently.

In some embodiments of the invention, other visual changes besides color can be made to visited hyperlinks. For example, the background color of a visited hyperlink can be changed. As another example visual distinction, the font sizes of visited hyperlinks can be changed to distinguish them from the unvisited hyperlinks. For example, the font size hyperlink text may transition from a small font size representing an unvisited site, to a larger final size representing a highly visited hyperlink. As another example visual distinction, the shade of a color can be changed. In addition, one or more of these visual distinctions can be used in combination to provide browsing behavior information to the user.

Each visual distinction can correspond to a different piece of browsing information. For example, both the font color and the background color can be applied to the same hyperlink. The background color could indicate the time of the visit, while the font color could indicate the length of the visit of the same hyperlink.

In accordance with the time/length of the visit, a variety of colors could be used within one hyperlink. For example, the first character of the hyperlink is red, the last one is yellow, and the color of the characters in between ranges between these two colors (various shades of orange).

In one embodiment, the system could also modify the rendering of a web page in a browser in such a way that the page will show a legend UI to the user. This legend visually explains what visual distinctions used on hyperlinks correspond to what browsing metrics on the target page.

Changing Visited Hyperlink Appearance

The embodiment of the invention using transition colors will now be used to describe how the visual appearance of visited hyperlinks can be changed to provide more information about a user's browsing behavior. It is to be understood the description below can be correspondingly applied to any of the visual distinctions described in this application. In one embodiment, a series of colors are used to transition between an unvisited hyperlink color and a visited hyperlink color in a way that corresponds to the length of time a user spent visiting the target of a hyperlink. This length of a user's visit may indicate how important or useful the user found the hyperlinked information.

The length of a user's visit to a web page can be measured in many ways. For example, the length of a user's visit can be measured from the time of selecting a hyperlink, to the time of leaving the hyperlinked web page. As another example, the length of visit may be considered the time from selecting the hyperlink to leaving any web page at the domain of the hyperlinked page. This can be useful, because once arriving at a target page, the user may follow additional hyperlinks linking to other web pages on the same domain. This measure of length of visit can be combined with other indicators of user interest, for example, only considering the time that a web page was visible to the user. A web page may only be visible to a user when it is a foreground tab, otherwise it may be in the background while another web page is in a foreground tab. Alternatively, the time of visit can be measured from the time a user opened a hyperlink in a new tab (or window) to the time that tab (or window) was closed, regardless of the web page's visibility to the user.

In another embodiment of the invention, hyperlink color can be changed only very slightly or not at all when the length of a user's visit is below a threshold. For example, a user selects a hyperlink accidentally and them immediately hits the back button of his web browser to return to the previous page. In this case, the hyperlink color does not need to be changed, or may be changed only slightly. This can be particularly useful on mobile browsers where small screens make the likelihood of selecting the wrong hyperlink greater.

The duration of a user's visit to a page can be measured and understood in multiple ways. For example, the measurement of duration can be for a single visit (e.g. the previous visit), or it can be cumulative over multiple visits. Therefore, the color of a hyperlink can change more the longer a user spends on a site through a particular hyperlink, or at the site in general from various hyperlinks. As another example, the measurement of the duration of a visit can also be made relative to a user's browsing habits and the average length of a visit to a website. If a user tends to visit most pages for 1 minute, a 5 minute visit can be indicated with a large change in color. However, if the user visits most pages for 15 minutes, then a 5 minute visit can be indicated with a small change in color. As another example, the measurement of duration can be made relative to the average length of visits of other users to that particular web page. Therefore, a user's visit of one minute to a page normally visited for 15 minutes by other users would not result in a large change of color to a visited hyperlink.

In one specific example, the shade of a color can be changed using HTML color hex values depending on the length of visit to a hyperlink, as shown in the following chart:

| Length of visit | Hex value |
|---|---|
| >10 minutes | #297ACC |
| 8-10 minutes | #3399FF |
| 5-8 minutes | #5CADFF |
| 3-5 minutes | #85C2FF |
| 2-3 minutes | #99CCFF |
| 1-2 minutes | #C2E0FF |
| <1 minute | #EBF5FF |

The color of a visited hyperlink can also be changed according to length of the visit relative to the amount of content on the hyperlinked page. For example, a 5 minute long visit on a page with a 45 minute long video can be considered a relatively short visit, but a 30 second long visit on a page containing a simple image can be interpreted as a relatively long visit.

In another embodiment of the invention, the color of the hyperlink changes the more times it has been used to visit a website. For example, the color of the hyperlink becomes one increment closer to a final visited hyperlink color each time the user has visited a particular website (either through a particular hyperlink, or any hyperlink hyperlinking to a certain page). Alternatively, the hyperlink changes color after a certain amount of visits (e.g. each 5 visits).

In another embodiment of the invention, the color of the hyperlink can change according to the last time of the visit. If the visit occurred closer in time (e.g. an hour ago), the hyperlink transitions more in color, but if the last visit occurred much earlier (one day ago), the hyperlink transitions back towards an unvisited hyperlink color. This transition may happen continuously over time.

In another embodiment of the invention, the color of the hyperlink can be based on the user's interaction with the visited page. For example, if the user selected any hyperlinks on the page, entered form data, interacted with UI elements, or played a video or other embedded content. These would all be indications that the user found that web page useful or important.

In yet another embodiment, the hyperlink's color could be based on a user group's activity, as opposed to a single user's activity. The user group could correspond to any user who has visited the actual page by clicking on the actual hyperlink, or the group could correspond to the user's social graph (circles).

### Continuously Changing Visited Hyperlink Appearance

In any of the described embodiments of the invention, the hyperlink color may transition back to an unvisited color as the user continues to browse. For example, a user may discover a new website and visit it frequently, resulting in a hyperlink color representing a highly visited hyperlink. After a period of time during which the user visits the website less frequently, the hyperlink color may transition back to an unvisited hyperlink color, indicating to the user that recently those hyperlinks may be relatively less important than the other hyperlinks. This transition may occur slowly, for example, by transitioning each hour one color towards an unvisited hyperlink color. As another example, the transition may happen with a change each day towards an unvisited hyperlink color.

### Reordering Search Results

The above embodiments of the invention can be used for a search results page, where a user may be going back and forth between a list of search results and the result pages themselves. Upon returning to the list of results, the user can easily see by how closely the visited hyperlink color is to a final visited hyperlink color, which hyperlinks they spent the longest at, and therefore which might be the most important.

In another embodiment of the invention, the order of the search results themselves can be changed to show the user how long they spent on the page. Accordingly, longer visits, suggesting more important pages, can be at the top of the list. This may be alone, or in combination with changing the appearance of visited hyperlinks. Similarly, hyperlinks or domains that have been visited more often can be re-ordered to appear early in the search results. This can be just one of many signals used to re-order search result.

Architecture

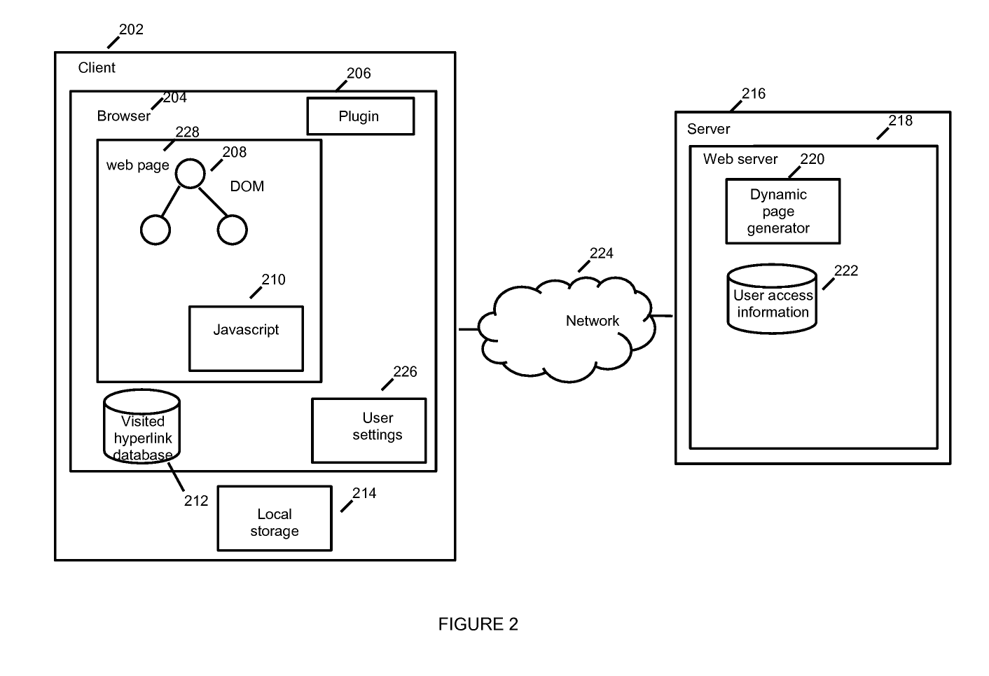

FIG. 2 is an architecture diagram showing a system for changing the appearance of visited hyperlinks in accordance with an embodiment of the invention. FIG. 2 shows a client server system connected through a communication network 224, for example, the Internet, a local area network, or a wide area network, any of which may use a wired or wireless connection.

Client system 202 is any computer system. For example, client system 202 can be a laptop, desktop, mobile phone, monitor, television, tablet computer, or other computing device.

Web browser 204 is an application running on computer system 202 and includes plugin 206 and visited hyperlink database 212, among other components that are not shown. Web browser can be a multi-tabbed browser capable of showing multiple web pages at the same time, or of showing a single tab in the foreground, while other tabs are in the background.

Plugin 202 can be an NSAPI plugin, browser extension, or any other type of add on to the browser that is capable of interacting with web pages and/or of monitoring user interactions. Embodiments of the invention can also be built directly into web browser 204. Embodiments of the invention can also be built as a plugin 206, so that existing web browsers can be easily updated with additional functionality as described by embodiments of the invention. The description below will be with respect to functionality incorporated into the web browser, but it is to be understood that the same functionality could be provided by any type of browser add on.

Visited hyperlink data 212 is a database of hyperlinks that have been visited by a user. This database can store information about a user's browsing that can be used by web browser 204. A user session can be maintained in many ways, including use of IP address or cookies. The database 212 can store for each visited URL the relevant information needed to visually change the appearance of visited hyperlinks in accordance with embodiments of the invention. Visited hyperlink database 212 can include for each visited hyperlink, the length of time a user spent at the target web page (or domain). As described above, the time can be cumulative, and can be updated by web browser each time a user visits the same web page (or domain). Visited hyperlink database can also include a count of the number of visits to a web page. Visited hyperlink database can also include other information about the web page that can be used to change the color of hyperlinks in accordance with the various embodiments described above. For example, the visited hyperlink database 212 can include the number of user visits, average length of time spent on page, average time spent by other users, amount of interaction with the page web, and amount of content. Alternatively, instead of adding information to a visited hyperlink database, a new database especially for the purpose of changing the color of visited hyperlinks can be used by web browser 204.

In another embodiment of the invention, JavaScript embedded in web page 228 can be used to measure the relevant information. For example, the selection of a hyperlink can generate an event that can be used to log the URL, along with the time the user selected the hyperlink, into local storage 214. Local storage 214 can be local storage such as HTML 5 local storage that is accessible to web applications through JavaScript. When a user returns to web page, the return time can also be logged into local storage 214. By recording the last page the user selected, it can be determined what page the user was likely viewing. This information can then be used to change the color of the hyperlink. Alternatively, JavaScript can be used to interact with visited hyperlink database, or another database, to store and retrieve the relevant information. In addition, using XMLHttpRequest, JavaScript can also store and retrieve the necessary information from a remote database. JavaScript can be inserted by the web browser, a plugin, or a browser extension. A browser extension can use a content script to inject the necessary JavaScript into a web page. JavaScript and JavaScript events can also be used to measure frequency of visit, and the amount of user interaction with a web page. In addition, HTML5 technologies can also be used to measure the relevant information. The Page Visibility API can be used by JavaScript to measure the amount of time a web page was actually visible.

The color of a visited hyperlink can be changed by changing the style attribute of an anchor “<a>” tag. This can be done using JavaScript that manipulates the document object model (DOM) 208 of the web page 228 the user is currently viewing. The JavaScript code can traverse the DOM 208 of the web page, checking hyperlinks to see if they have been visited. Once a visited hyperlink has been found, relevant information about the hyperlink can be looked up in visited hyperlink database 212, and the style attribute of the hyperlink can be changed in accordance with the desired change in visual appearance. Alternatively, changing the color of a visited hyperlink can be done through CSS and modification of CSS selectors and corresponding styles.

In another embodiment of the invention, changing visited hyperlink color can be performed by the browser itself. This code can be built into the rendering component of the browser. As the rendering component is rendering visited hyperlinks, it can change the color of a hyperlink as necessary.

In another embodiment of the invention, changing the color of a visited hyperlink can be performed by a web server 218 running on server 216. A web server serving dynamically generated pages can send web pages (e.g. HTML) to the client 202 that already have visited hyperlinks properly colored. For example, a search engine provider can have results pages point to a server of the search engine provider and then send the user a redirect to their desired page. Accordingly, the search engine provider can determine which hyperlinks a user selected and when that hyperlink was selected. Later, when the user returns to the search results page, search engine provider would know that the user was done viewing the first web page, and can use this information to color the hyperlink that was visited.

In another embodiment of the invention, a web server serving a web application or website to a user can monitor a user as they browse various web pages of the web application or website, and can provide visited hyperlink colors in accordance with the user's browsing. For example, a news site can determine which web pages a user is viewing and store this information in a database 222 of user access information. The news site can then refer to the database when generating new web pages for a user. For example, when the user returns to a home page of the web site, the visited hyperlink color for news articles can correspond to the amount of time the user spent reading the article. Alternatively, information gathered from processing server logs can be used to color visited hyperlinks. In addition, XMLHttpRequest can be used to monitor a user's interaction with a web application or web site and be used to color visited hyperlinks.

In addition, web server can use information from the browsing of other users to color hyperlinks for a user. Over time, a web server can determine how long an average user views a particular web page, or how much an average user interacts with a particular web page. The visited hyperlink colors provided to a user can be provided relative to this average.

User settings 226 can be various user settings allowing a user to control how visited hyperlinks are colored. These settings can include allowing a user to a set a threshold number of visits, a threshold length of a visit, or a threshold amount of interaction with a web page. These settings can also include how many and what colors to use. These settings can be synced with a server to provide a user a consistent experience as the user uses a different browser and/or device. The latest settings can be downloaded from the server when a user uses a new browser or device.

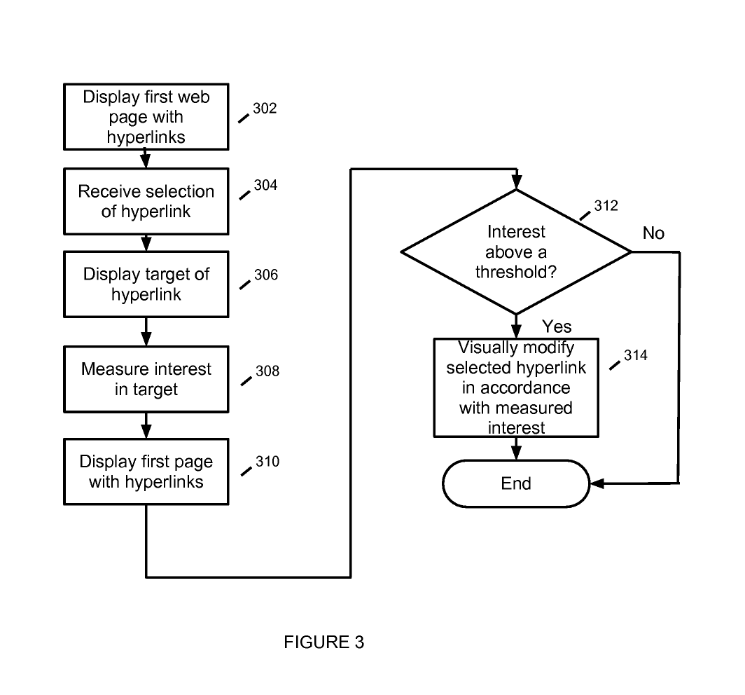

FIG. 3 is a flow diagram showing changing visited hyperlink color in accordance with an embodiment of the invention.

At stage 302, a web page with one or more hyperlinks is displayed. These hyperlinks can be to various types of resources, including other web pages (with or without more hyperlinks), images, videos, sounds, data files, and applications.

At stage 304, the browser receives the selection of a hyperlink and retrieves the resource to display to the user.

At stage 306, the resource is displayed to the user. The resource may be displayed within the browser itself, a built in player (e.g. built in flash player), or using a plugin.

At stage 308, the user's interest in the resource is measured. The measurement depends on what is being monitored, and what metrics are used to change the visual appearance of hyperlinks. For example, if the metric is duration of a user's visit, then the start time of viewing a web page, and the end time of viewing a web page can be collected. As another example, if the metric is user interaction, the number of mouse clicks or touch events on a target web page can be counted.

At stage 310, an indication is received from the user to return to a previous web page, and the first web page is displayed for the user. For example, the user may be returning to a search results page after viewing one of a number of search results.

At stage 312, if the measured metric of interest is above a threshold, then the selected hyperlink is visually modified at stage 314. Otherwise, the process ends. This may be the case, for example, if a user accidentally clicked on a hyperlink and only viewed it for a short time (e.g. less than a second). Similarly, the user might have tried to return to the previous page before the target web page had finished loading, or before the target web page had finished rendering. Accidental selection can also be determined by a user going back to the previous page before all the resources of the target web page, such as images, cascading style sheets, and script files, have been loaded. This short viewing time of a hyperlink may not be above the threshold set for visually modifying a hyperlink, and therefore no visual modifications are performed. For example, a user may have viewed a page for one second before returning to the previous page. In that situation, the visit may not be counted in the visited hyperlink database, resulting in not visually changing the hyperlink color to a visited hyperlink color. Other indications of accidental selection include, selection of a hyperlink resulting in an error on the client system, or an error being returned from the server system. Errors returned from a server system can include redirects and page not found errors.

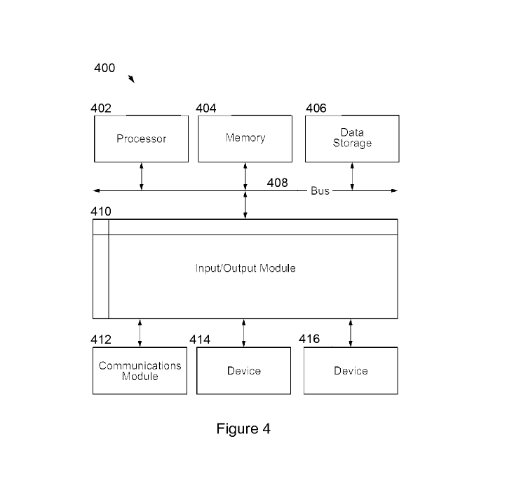

FIG. 4 is a block diagram illustrating an exemplary computer system 400 with which the client 202 and server 216 of FIG. 2 can be implemented. In certain aspects, the computer system 400 may be implemented using hardware or a combination of software and hardware, either in a dedicated server, or integrated into another entity, or distributed across multiple entities.

Computer system 400 (e.g., client 202 or server 216) includes a bus 408 or other communication mechanism for communicating information, and a processor 402 coupled with bus 408 for processing information. By way of example, the computer system 400 may be implemented with one or more processors 402. Processor 402 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry.

The instructions may be stored in the memory 404 and implemented in one or more computer program products, i.e., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 510 to various devices. The input/output module 410 can be any input/output module. Exemplary input/output modules 410 include data ports such as USB ports. The input/output module 510 is configured to connect to a communications module 412. Exemplary communications modules 412 include networking interface cards, such as Ethernet cards and modems. In certain aspects, the input/output module 410 is configured to connect to a plurality of devices, such as an input device 414 and/or an output device 416. Exemplary input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 416 include display devices, such as a CRT (cathode ray tube) or LCD (liquid crystal display) monitor, for displaying information to the user.

According to one aspect of the present disclosure, the client 202 and server 216 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

1. A method for visually indicating a user's browsing history on a results page, the method comprising:
detecting an accidental selection of a result, the detecting being effected based on a length of time spent browsing a selected web page;
changing the results page to provide a visual indication distinguishing the result accidentally selected from other selected results; and
displaying the changed results page including the result accidentally selected.

2. The method of claim 1, wherein the visual indication is a change in color of the result.

3. The method of claim 2, further comprising:
changing the color of the result by modifying an attribute of a web page document object model node using Javascript.

4. The method of claim 1, wherein the length of time is provided by a user setting.

5. The method of claim 4, further comprising:
synchronizing a user setting with a remote server.

6. The method of claim 1, wherein the results page is a search results page including a plurality of hyperlinks.

7. The method of claim 6, wherein an order of the plurality of hyperlinks is based on the other selected results.

8. The method of claim 1, further comprising:
storing a target web page and time of selection of the accidental selection in a database;
receiving an indication to return to the results page; and
computing a visit duration based on the stored time of selection, and a received indication to return to the result page.

9. A system for visually indicating a user's browsing history on a results page, the system comprising:
a detector for detecting an accidental selection of a result, the detector indicating an accidental selection based on a length of time spent browsing a selected web page;
a processor for changing the results page to provide a visual indication distinguishing the result accidentally selected from other selected results; and
a display for displaying the changed results page including the result accidentally selected.

10. The system of claim 9, wherein the visual indication is a change in color of the result.

11. The system of claim 10, further comprising:
the processor changing the color of the result by modifying an attribute of a web page document object model node using Javascript.

12. The system of claim 9, wherein the length of time is provided by a user setting.

13. The system of claim 12, further comprising:
synchronizing a user setting with a remote server.

14. The system of claim 9, wherein the results page is a search results page including a plurality of hyperlinks.

15. The system of claim 14, wherein an order of the plurality of hyperlinks is based on the other selected results.

16. The system of claim 9, further comprising:
a storage component for storing a target web page and time of selection of the accidental selection in a database;
the processor receiving an indication to return to the results page; and
the processor computing a visit duration based on the stored time of selection, and a received indication to return to the result page.

17. A non-transitory computer readable medium comprising machine-readable instructions for performing a method for visually indicating a user's browsing history on a results page, the method comprising:
detecting an accidental selection of a result, the detecting being effected based on a length of time spent browsing a selected web page;
changing the results page to provide a visual indication distinguishing the result accidentally selected from other selected results; and
displaying the changed results page including the result accidentally selected.

18. The computer readable medium of claim 17, further comprising:
changing a color of the result by modifying an attribute of a web page document object model node using Javascript.

19. The computer readable medium of claim 18, wherein the results page is a search results page including a plurality of hyperlinks, and an order of the plurality of hyperlinks is based on the other selected results.

20. The computer readable medium of claim 17, further comprising:
storing a target web page and time of selection of the accidental selection in a database;
receiving an indication to return to the results page; and
computing a visit duration based on the stored time of selection, and a received indication to return to the result page.

21. The method of claim 2, further comprising:
selecting the color to change the result based at least in part on the length of time spent browsing the selected web page, wherein a first color is selected when a first length of time is spent browsing the selected web page and a second color is selected when a second length of time is spent browsing the selected web page, the second color being different than the first color.
